(19) United States
(12) Patent Application Publication
(10) Pub. No.: US 2011/0298383 A1
(43) Pub. Date: Dec. 8, 2011

(54) ELECTRONIC OPERATING DEVICE FOR A GAS DISCHARGE LAMP

(75) Inventor: Joachim Muehlschlegel, Groebenzell (DE)

(73) Assignee: OSRAM GESELLSCHAFT MIT BESCHRAENKTER HAFTUNG, Muenchen (DE)

(21) Appl. No.: 13/202,103

(22) PCT Filed: Jan. 29, 2010
(86) PCT No.: PCT/EP2010/051043

§ 371 Date: Aug. 18, 2011

(30) Foreign Application Priority Data
Feb. 20, 2009 (DE) 10 2009 009 892.5

(51) Int. Cl. H05B 41/26

(52) U.S. Cl. 315/206

(57) ABSTRACT

The invention relates to an electronic operating device for a gas discharge lamp having: a DC/DC voltage converter, a power factor correction circuit, an inverter, a lamp inductor, and having a full bridge with two half bridges which can be controlled separately, wherein the DC/DC voltage converter additionally acts as a voltage step-down converter, and the inverter additionally has the following functions: lamp current regulation, the function of stepping down the voltage to the lamp voltage, and resonant ignition.

### TECHNICAL FIELD

The invention relates to an electronic operating device for a gas discharge lamp, having a DC/DC voltage converter which features a power factor correction circuit, and having an inverter which features a lamp inductor and a full bridge comprising two half bridges that can be activated separately.

### PRIOR ART

The invention takes as its starting point an electronic operating device for a gas discharge lamp, having a DC/DC voltage converter which features a power factor correction circuit, and having an inverter which features a lamp inductor and a full bridge comprising two half bridges that can be activated separately, of the type specified in the main claim.

FIG. 1 shows the existing design of an electronic operating device according to the prior art. This consists of three stages: in a first stage including the DC/DC voltage converter, the input AC voltage is stepped up to a so-called intermediate circuit voltage U_{ZK} of 400 V. The intermediate circuit voltage U_{ZK} is a DC voltage which is usually supported by an intermediate circuit capacitor. The DC/DC voltage converter works in a special mode, such that it can fulfill the function of a power factor correction circuit at the same time. The DC/DC voltage converter can be embodied as a flyback converter, a Sepic converter or a Cuk converter, for example.

In a second stage which follows thereupon and features an inverter in a half-bridge arrangement, the DC voltage of 400 V is stepped down to a low-frequency AC voltage at the level of the lamp voltage. The frequency of the AC voltage is usually between 50 and 500 Hz in this case. By virtue of the intermediate circuit voltage U_{ZK} being more than twice as high as the lamp voltage, provision can be made in the inverter for selecting a half-bridge arrangement which halves the output voltage relative to the input voltage in a customary manner. This stepped-down output AC voltage is then input into an ignition stage, which generates an ignition voltage for starting the gas discharge lamp 5.

The ignition stage normally consists of a superimposed igniter, which superimposes a high ignition voltage onto the output voltage of the inverter. In this case, the ignition voltage of the superimposed igniter consists of individual ignition pulses which are generated until an electrical breakdown occurs in the burner of the gas discharge lamp.

For reasons of efficiency and electromagnetic compatibility, the step-down half bridge in the inverter operates in discontinuous mode. This allows a complete discharge of the energy store and therefore minimizes the switching losses. The lamp inductor is usually used as an energy store in this context. However, a significant ripple current through the energy store is produced in this operating mode, and therefore the inverter generates an AC voltage of low frequency, onto which a high-frequency AC voltage is modulated. As a result of the complete charging/discharging, the ripple current through the energy store is triangular and generates a similarly shaped ripple voltage on the output AC voltage of the inverter. Since this high-frequency ripple voltage can stimulate acoustic resonances in the burner vessel, it is undesirable and must be filtered before the lamp. This is usually effected by means of a large filter capacity, which smoothes out the ripple voltage and prevents the stimulation of acoustic resonances thus. This is possible because the frequency of the operating AC voltage is considerably lower than the frequency of the added modulated voltage ripple coming from the ripple current in the energy store. Due to the large filter capacity that is required, however, only a superimposed igniter can be used as an igniter. The use of an arrangement for resonant ignition is not possible as a result of the large filter capacity.

### OBJECT OF THE INVENTION

The object of the invention is to specify an electronic operating device for a gas discharge lamp, having a DC/DC voltage converter which features a power factor correction circuit, and having an inverter which features a lamp inductor and a full bridge including two half bridges that can be activated separately, wherein said electronic operating device can use a resonant ignition circuit as an ignition stage.

### STATEMENT OF THE INVENTION

The object is achieved according to the invention by means of an electronic operating device for a gas discharge lamp, having:
a DC/DC voltage converter which features
a power factor correction circuit,
an inverter which features a lamp inductor and
a full bridge comprising two half bridges that can be activated separately,
   characterized in that
the DC/DC voltage converter additionally acts as a voltage step-down converter, and that
the inverter additionally has the following functions:
lamp current regulation,
the function of stepping down the voltage to the lamp voltage, and
resonant ignition.

This circuit topology can be implemented very economically, as it is possible to dispense with an ignition stage including an ignition transformer and high component costs by virtue of the intermediate circuit voltage.

In this case, the DC/DC voltage converter is preferably so configured as to step down the input voltage to an intermediate circuit voltage of 160 V-250 V. This measure allows the use of significantly less expensive components, since a voltage limit that applies in the case of semiconductor component technology is not reached.

If the lamp current regulation in the inverter takes place in such a way that the half bridge responsible for the step-down function operates in continuous mode, the ripple current in the lamp inductor becomes small and acoustic resonances in the lamp are avoided. In this case, the momentary value of the lamp current corresponds essentially to the momentary value of the current in the lamp inductor. By virtue of this operating mode, the stimulation of acoustic resonances is prevented in the gas discharge lamp burner, thereby resulting in stable operation.

In this case, the inverter preferably has a lamp inductor and a resonance capacitor, wherein the resonance inductor is embodied as an autotransformer whose center tap is connected to the resonance capacitor. This arrangement provides an effective resonance circuit for the ignition of the lamp. If the current flow through the resonance capacitor can be disconnected by means of a switch that is connected to the resonance capacitor, said switch being contacted during the ignition and take-over of the lamp and then disconnected during the run-up and nominal operation of the lamp, it is possible to ensure an effective and safe operating mode of the circuit arrangement because the resonance circuit is interrupted during the nominal operation.

An intermediate circuit capacitor, which maintains a voltage ripple during the operation, is preferably arranged between the DC/DC voltage converter and the inverter, wherein the AC voltage generated by the inverter is synchronized with the voltage ripple. In this case, the inverter is synchronized relative to the frequency of the voltage ripple in such a way that the AC voltage always commutates in the region of the maximum of the voltage ripple. This measure ensures a high voltage during the commutation, thereby significantly reducing the risk of the gas discharge lamp going out during the commutation.

In a preferred embodiment, the lamp current is preferably square-wave and the height of the lamp current is preferably adapted such that the momentary lamp power in the positive quadrant of the lamp current has the same magnitude as in the negative quadrant of the lamp current. In another preferred embodiment, the sampling ratio of the lamp current is adjusted such that the average lamp power in the positive quadrant of the lamp current has the same magnitude as in the negative quadrant of the lamp current. As a result, the lamp electrodes are heated equally and do not wear asymmetrically.

The full bridge is preferably operated in such a way that it is divided into two half bridges, the first half bridge being activated using a high-frequency pulse-width modulated voltage and the second half bridge being activated using a low-frequency square-wave voltage during the operation of the gas discharge lamp. As a result of this operating mode, a low-frequency AC voltage and step-down operation can be realized using a full bridge. In order to generate a suitable stimulation frequency for the resonance circuit, both half bridges are activated using a high-frequency voltage when starting the lamp.

Further advantageous developments and embodiments of the electronic operating device for a gas discharge lamp are derived from the further dependent claims and from the following description.

### BRIEF DESCRIPTION OF THE DRAWING(S)

Further advantages, features and details of the invention are revealed with reference to the following description of exemplary embodiments and with reference to the drawings, in which identical or functionally identical elements are denoted using identical reference signs and in which:

FIG. 1 shows a schematic block diagram of an electronic operating device according to the prior art,

FIG. 2 shows a schematic block diagram of an electronic operating device according to the invention,

FIG. 3 shows a schematic circuit diagram of an inverter according to the invention in a first embodiment,

FIG. 4 shows a schematic circuit diagram of an inverter according to the invention in a second embodiment.

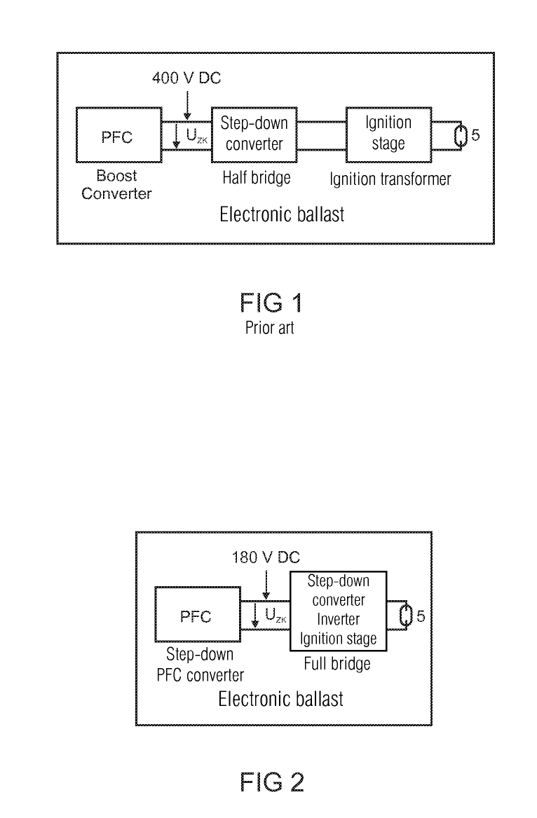

### PREFERRED EMBODIMENT OF THE INVENTION

FIG. 2 shows a schematic block diagram of an electronic operating device according to the invention. The electronic operating device according to the invention includes only 2 stages. In the first stage, which contains the DC/DC voltage converter, the input AC voltage is converted into an intermediate circuit voltage U_{ZK} of approximately 180 V. For this purpose, the DC/DC voltage converter features a step-down function in addition to the power factor correction, since it reduces the rectified 220 V AC voltage from −325 V to an intermediate circuit voltage U_{ZK} of ˜180 V, for example.

In the subsequent 2nd stage, which features the inverter, the intermediate circuit voltage U_{ZK} is converted to a low-frequency AC voltage. A half bridge of the inverter full bridge acts as a step-down switch in this case, reducing the intermediate circuit voltage U_{ZK} to the lamp voltage of lower magnitude. The other half bridge of the full bridge operates using a low-frequency AC voltage in this case. In this way, a low-frequency AC voltage is generated which is reduced by means of the step-down half bridge to the magnitude of the lamp voltage. Since the intermediate circuit voltage U_{ZK} is already considerably low, the inverter is constructed as a full-bridge arrangement.

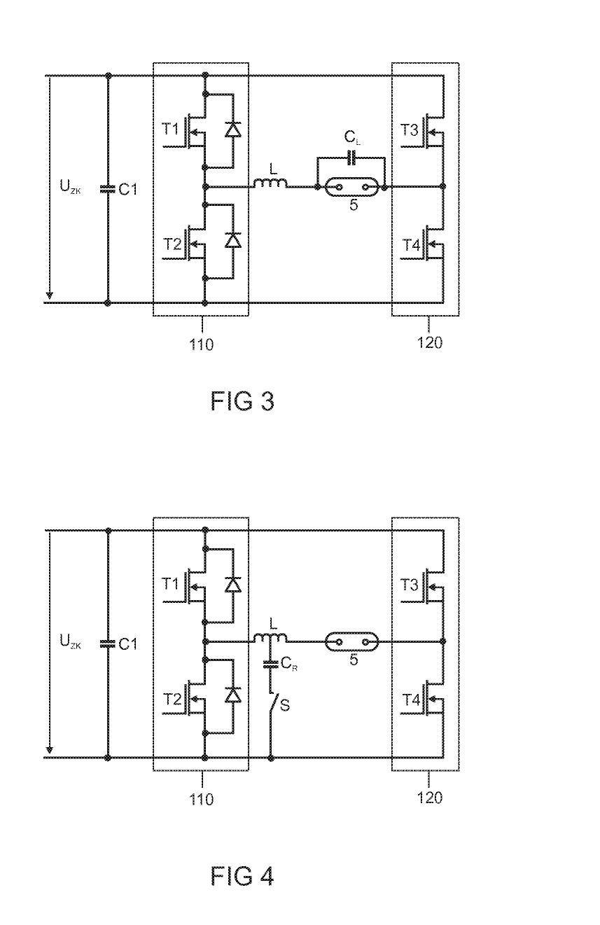

FIG. 3 shows a schematic circuit diagram of the full-bridge arrangement in a first embodiment. The intermediate circuit voltage U_{ZK}, which serves as an input voltage here, is supported by an intermediate circuit capacitor C1. A first half bridge 110 features the MOS-FETs T1 and T2. Connected in parallel with the MOS-FETs in each case is a freewheeling diode. This has better electrical properties than the freewheeling diodes within the MOS-FETs. These are advantageous in the context of said half bridge 110, as it assumes responsibility for the step-down function and is consequently activated using a high frequency. A lamp inductor L is connected to the central point of this half bridge 110, and simultaneously acts as a step-down inductor. The gas discharge lamp 5 is connected in series with the lamp inductor L. The second half bridge 120 is connected at its central point to the other end of this series connection. The second half bridge 120 features the MOS-FETs T3 and T4. These transistors are responsible for generating the low-frequency AC voltage which is applied to the gas discharge lamp 5. As mentioned above, they therefore reverse the current direction through the gas discharge lamp 5 in a low-frequency cycle. For the purpose of this task, the freewheeling diodes that are integrated in the MOS-FETs are sufficient. For this reason, no freewheeling diodes are connected in parallel with the MOS-FETs of the half bridge 120.

An ignition capacitor C_{L} is connected in parallel with the gas discharge lamp 5. In the circuit arrangement according to the invention, during the lamp run-up and in particular after the lamp run-up, i.e. when the lamp has reached the nominal operating point, the step-down half bridge 110 works in continuous mode, during which the lamp inductor L acting as a step-down inductor is not completely discharged in one cycle.

This has the disadvantage of increased switching losses, but has at the same time the advantage of a significantly smaller current ripple due to the reduced discharge depth of the lamp inductor L. As a result of this considerably smaller current ripple, a filter capacitor can be omitted completely, and the capacitor is therefore only used as an ignition capacitor for resonant ignition.

The prominent higher switching losses of the circuit arrangement according to the invention are minimized by the overall concept. By virtue of the considerably lower intermediate circuit voltage of just 160 V-250 V (preferably between 160 V and 230 V) in comparison with the prior art, the switching losses are reduced to a minimum, such that the circuit arrangement according to the invention actually exhibits barely higher switching losses than a circuit arrangement from the prior art. This can be estimated very easily as follows: the switching work of a transistor when discharging the effective switch capacity is described as: W_{switch}=½C*U². Since the voltage here arrives as a square wave, the losses at half voltage are only a quarter of the original losses. Low switching losses generate low interferences, however, and this in turn improves the electromagnetic compatibility.

In this case, the step-down half bridge 110 preferably works using quadrant-selective current regulation, which maintains an equal lamp power magnitude during the positive half-wave and during the negative half-wave. In a first variant, the power is regulated in this case to a predetermined power at each operating point. This requires rapid current regulation which is able to regulate the pulse-width modulation as a function of the momentary lamp voltage. In a second, simpler variant, the lamp power is only regulated over a whole half-wave, such that simpler slower regulation can be used, this being more economical to implement.

As a result of the advantageous low intermediate circuit voltage, it is possible to use freewheeling diodes of a type having a correspondingly low blocking voltage, these having considerably better properties in respect of their electrical behavior than higher blocking types which are required to be used in the prior art. Low-blocking diode types are considerably faster and exhibit significantly softer recovery behavior, which in turn improves the electromagnetic compatibility and further counterbalances the disadvantage of the hard switching. Schottky diodes, which are also commercially available for the intermediate circuit voltage of the circuit arrangement according to the invention, exhibit even better properties and further improve the advantages of the inventive design.

In order to ignite the gas discharge lamp 5, the step-down half bridge 110 is stimulated using the resonance frequency of a resonance circuit consisting of the lamp inductor L and the filter capacitor C_{L}. The voltage that is present at the filter capacitor C_{L} oscillates by virtue of the resonance at a level which results in an electrical breakdown in the gas discharge lamp burner of the gas discharge lamp 5. Using skillful control of the activation frequency of the step-down half bridge 110, the voltage at the gas discharge lamp can also be increased after its ignition, in order to achieve improved starting behavior of the gas discharge lamp. As soon as the lamp is in a defined burning state, the step-down half bridge is controlled in such a way that it performs the current-regulating function and the gas discharge lamp is therefore operated using power regulation.

A schematic circuit diagram of the full-bridge arrangement in a second embodiment is shown in FIG. 4. This embodiment is similar to the first embodiment, and therefore only the differences relative to the first embodiment are explained. Instead of the ignition capacitor C_{L} which is connected in parallel with the lamp, the full bridge in the second embodiment features a series connection including a resonance capacitor C_{R} and a switch S. This series connection is connected from a center tap of the lamp or resonance inductor L, this being embodied as an autotransformer, to the negative input voltage U_{ZK}. The switch S is now closed before the start of the ignition, such that a current path and hence a resonance circuit is produced by the lamp inductor L and the resonance capacitor C_{R}. After the ignition of the gas discharge lamp, the switch is left in the closed state for a short time in order to apply a higher take-over voltage, this being produced by the resonance step-up, to the gas discharge lamp. Take-over here refers to that phase of the gas discharge lamp, shortly after the electrical breakdown in the lamp burner, in which the burning voltage is still very low and the electrodes are still very cold. As a result of the cold electrodes in the take-over phase, the gas discharge lamp requires a very high voltage in order that it does not go out during the next current commutation. When the take-over phase is complete, and the electrodes of the gas discharge lamp have a sufficiently high voltage, the switch S is opened and the current path is therefore interrupted. This also interrupts the resonance circuit, whereupon an overvoltage is no longer generated and the step-down half bridge 110 can reduce the input voltage U_{ZK} directly to the lamp voltage. The switch remains open for the entire duration of the run-up, i.e. the time during which the gas discharge lamp is not yet operated at its nominal power. The switch S also remains open at the nominal operating point, at which the lamp is operated at its nominal power, and is only closed again for the purpose of igniting the gas discharge lamp after it has gone out.

The operating device according to the invention is particularly suitable for operating mercury-free high-pressure discharge lamps, since it offers significant advantages over the prior art:
The switching frequency of the half bridge can be freely selected, since hard switching is used in the continuous mode. This represents a significant advantage over the conventional discontinuous mode, in which the frequency cannot be freely selected because the frequency is derived from the ZCS condition (Zero Current Switching). Using the topology, it is therefore easily possible to modulate a higher frequency onto the low-frequency square-wave current, applying a specific degree of modulation and a desired frequency. This modulation is used for arc straightening in mercury-free high-pressure discharge lamps.
Mercury-free high-pressure discharge lamps have a low burning voltage of approximately 40 to 90 V. The current is correspondingly high. The topology is therefore advantageous because fewer losses occur in the low-voltage MOS-FETs than in the case of a switching topology according to the prior art.

For the low burning voltages of mercury-free high-pressure discharge lamps, the first stage (functioning as a power factor correction circuit) can be implemented as a simple step-down converter (buck converter). A switching topology which can step up and step down (buck-boost) is therefore not required. This has advantages with regard to the circuit arrangement and the power loss.

By virtue of the operating device according to the invention, it is possible to dispense with a complete stage for operating a gas discharge lamp, and the costs can therefore be significantly reduced. The component costs of an additional ignition stage are economized because the step-down half bridge is operated in the continuous mode and the filter capacitor can be very small.

1. An electronic operating device for a gas discharge lamp, the electronic operating device comprising:
a DC/DC voltage converter which features
a power factor correction circuit,
an inverter which features a lamp inductor and
a full bridge comprising two half bridges that can be activated separately,
wherein the DC/DC voltage converter additionally acts as a voltage step-down converter, and
wherein the inverter additionally has the following functions:
lamp current regulation,
the function of stepping down the voltage to the lamp voltage, and
resonant ignition.

2. The electronic operating device as claimed in claim 1,
wherein the DC/DC voltage converter is configured to step down the input voltage to an intermediate circuit voltage of 160 V-250 V.

3. The electronic operating device as claimed in claim 1,
wherein the lamp current regulation in the inverter takes place in such a way that the half bridge responsible for the step-down function operates in continuous mode, such that the ripple current in the lamp inductor is small and acoustic resonances in the lamp are avoided, wherein the momentary value of the lamp current corresponds essentially to the momentary value of the current in the lamp inductor.

4. The electronic operating device as claimed in claim 1,
wherein the inverter comprises a lamp inductor and a resonance capacitor, wherein the resonance inductor is embodied as an autotransformer whose center tap is connected to the resonance capacitor.

5. The electronic operating device as claimed in claim 4,
wherein the current flow through the resonance capacitor can be disconnected by means of a switch that is connected to the resonance capacitor, said switch being contacted during the ignition and take-over of the lamp and then disconnected during the run-up of the lamp and in nominal operation of the lamp.

6. The electronic operating device as claimed in claim 1,
wherein an intermediate circuit capacitor which maintains a voltage ripple during the operation is arranged between the DC/DC voltage converter and the inverter, wherein the AC voltage generated by the inverter is synchronized with the voltage ripple.

7. The electronic operating device as claimed in claim 4,
wherein the inverter is synchronized relative to the frequency of the voltage ripple in such a way that the AC voltage always commutates in the region of the maximum of the voltage ripple.

8. The electronic operating device as claimed in claim 4,
wherein the lamp current is square-wave and the height of the lamp current is adapted such that the momentary lamp power in the positive quadrant of the lamp current has the same magnitude as in the negative quadrant of the lamp current.

9. The electronic operating device as claimed in claim 4,
wherein the sampling ratio of the lamp current is adjusted such that the average lamp power in the positive quadrant of the lamp current has the same magnitude as in the negative quadrant of the lamp current.

10. The electronic operating device as claimed in claim 1,
wherein the full bridge is divided into two half bridges, wherein during the operation of the gas discharge lamp the first half bridge is activated using a high-frequency pulse-width modulated voltage and the second half bridge is activated using a low-frequency square-wave voltage.

11. The electronic operating device as claimed in claim 8,
wherein both half bridges are activated using a high-frequency voltage when starting the lamp.
